(19) United States
(12) Patent Application Publication
(10) Pub. No.: US 2023/0290270 A1
(43) Pub. Date: Sep. 14, 2023

(54) Ambient Augmented Language Tutoring

(71) Applicant: Apple Inc., Cupertino, CA (US)

(72) Inventors: Brian W. Temple, Santa Clara, CA (US); Devin W. Chalmers, Oakland, CA (US); Thomas G. Salter, Foster City, CA (US)

(21) Appl. No.: 18/112,450

(22) Filed: Feb. 21, 2023

Related U.S. Application Data
(60) Provisional application No. 63/317,776, filed on Mar. 8, 2022.

(51) Int. Cl. G09B 19/06; G06T 19/00; G06F 3/01

(52) U.S. Cl. CPC G09B 19/06; G06T 19/006; G06F 3/011

(57) ABSTRACT

Devices, systems, and methods that facilitate learning a language in an extended reality (XR) environment. This may involve identifying objects or activities in the environment, identifying a context associated with the user or the environment, and providing language teaching content based on the objects, activities, or contexts. In one example, the language teaching content provides individual words, phrases, or sentences corresponding to the objects, activities, or contexts. In another example, the language teaching content requests user interaction (e.g., via quiz questions or educational games) corresponding to the objects, activities, or contexts. Context may be used to determine whether or how to provide the language teaching content. For example, based on a user's current course of language study (e.g., this week's vocabulary list), corresponding object or activities may be identified in the environment for use in providing the language teaching content.

### CROSS-REFERENCE TO RELATED APPLICATIONS

This application claims the benefit of U.S. Provisional Application Ser. No. 63/317,776 filed Mar. 8, 2022, which is incorporated herein in its entirety.

### TECHNICAL FIELD

The present disclosure generally relates to electronic devices that provide language tutoring in views of three-dimensional (3D) content such as augmented reality (AR) and other extended reality (XR) experiences.

### BACKGROUND

Students and other people of all ages seek to learn to speak, understand, write, or read one or more languages. Electronic devices may not adequately support such learning.

### SUMMARY

Various implementations disclosed herein include devices, systems, and methods that facilitate learning a language using an extended reality (XR) environment that may be at least partially based on the surrounding physical environment. Implementations may involve identifying objects or activities in the environment, identifying a context associated with the user or the environment, and providing language teaching content based on the objects, activities, or contexts. In one example, the language teaching content provides visual or audible content that includes individual words, phrases, or sentences corresponding to the objects, activities, or contexts. In another example, the language teaching content requests user interaction (e.g., via quiz questions or educational games) corresponding to the objects, activities, or contexts. Context may be used to determine whether or how to provide the language teaching content. For example, based on a user's current course of language study (e.g., this week's vocabulary list), corresponding objects or activities may be identified in the environment for use in providing the language teaching content. The language teaching content and associated user input may be visual or audible.

In some implementations, a processor performs a method by executing instructions stored on a computer readable medium. The method may involve acquiring sensor data during use of the device by a user in a physical environment that includes an object or activity. The sensor data may include images of the physical environment captured via a camera on the device (e.g., via an RGB camera, a LIDAR sensor, a microphone, an ambient light sensor, etc.). The method may identify the object or the activity based on the sensor data, for example, using a computer-vision based scene understanding technique.

The method may identify a context based on the physical environment or the user. In one example, identifying the context includes identifying an indication of user (or other person's) interest in an object/activity based on gaze, holding, touching, etc. In another example, identifying the context includes determining the relevance of an object, activity, or environment type to the user's current topic or lesson, such as this week's 20 Spanish vocabulary words. In another example, identifying the context includes determining the user's language level, current vocabulary, or history, which, for example, may be determined based on observing the user's use of language.

The method may determine to provide language teaching content in the XR environment based on the object or activity and the context and provide the XR environment including the language teaching content to the user. Other user activities or plans (e.g., whether the user is working or socializing) may be used to determine whether a current time and location (e.g., in the present XR environment) are desirable for language instruction. The location of the language teaching content (e.g., its 3D position relative to other content in the XR environment) may be determined to facilitate language learning. For example, such language learning content may be spatially positioned proximate to the object or activity to which it relates.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary context of an exemplary electronic device operating in a physical environment in accordance with some implementations.

FIGS. 2A-C illustrate depictions of language learning content provided by the electronic device of FIG. 1 in accordance with some implementations.

FIG. 3 illustrates another exemplary context of the electronic device operating in the physical environment in accordance with some implementations.

FIGS. 4A-C illustrate depictions of language learning content provided by the electronic device of FIG. 3 in accordance with some implementations.

FIG. 5 is a flowchart illustrating a method for providing content to facilitate language learning in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

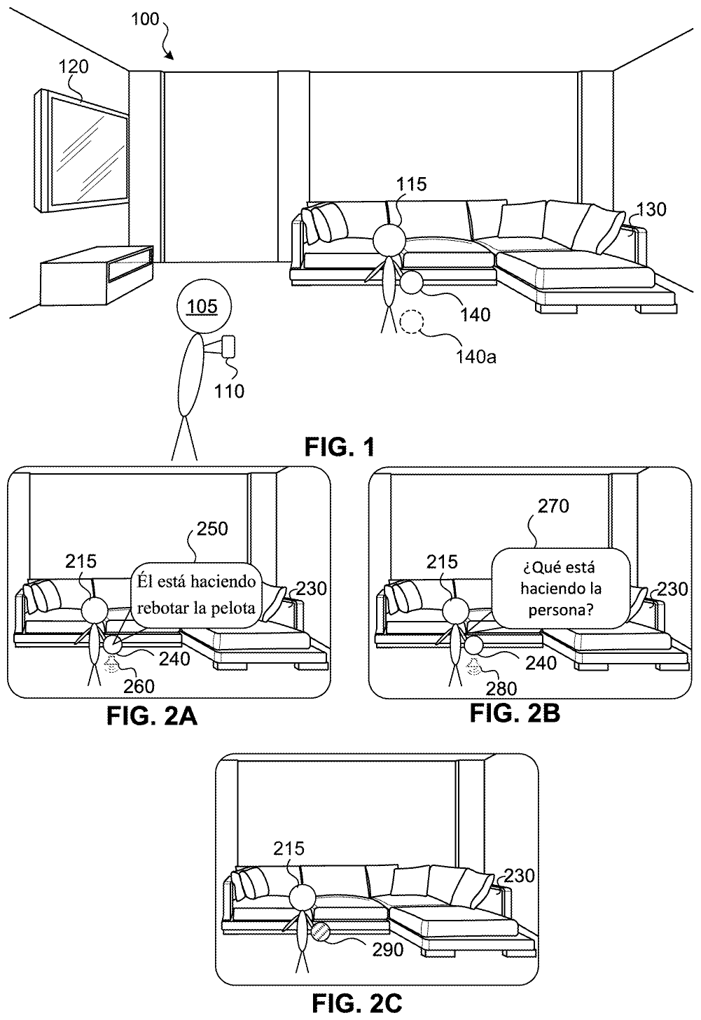

FIG. 1 illustrates an exemplary electronic device 110 operating in a physical environment 100. In this example of FIG. 1, the physical environment 100 is a room that includes a floor, a television 120, a couch 130, another person 115, and a ball 140, among other things. The electronic device 110 includes one or more cameras, microphones, depth sensors, motion sensors, or other sensors that can be used to capture information about and evaluate the physical environment 100 and the objects within it, as well as information about the user 105 of the electronic device 110. The information about the physical environment 100 or user 105 may be used to provide visual or audio content that facilitates learning one or more languages. The electronic device 110 may be (but is not necessarily) involved in providing an extended reality (XR) environment.

FIGS. 2A-C illustrate depictions of language learning content provided by the electronic device of FIG. 1.

FIG. 2A illustrates a view of an XR environment that includes depictions of the physical environment 100 of FIG. 1 and virtual content intended to facilitate learning aspects of the Spanish language. In this example, the XR environment includes depictions of aspects of the physical environment 100 of FIG. 1, e.g., including a depiction 215 of the other person 115, depiction 230 of the couch 130, and depiction 240 of the ball 140. In this example, the XR environment also includes visual and audible virtual content intended to facilitate learning the Spanish language. In particular, the XR environment includes a text bubble 250 with the Spanish language phrase “Él está haciendo rebotar la pelota” (He is bouncing the ball) and audio (signified by audio graphic 260) that presents the same phrase (“Él está haciendo rebotar la pelota”) audibly. The user 105 thus experiences language instruction that is relevant to the user's real-world environment in the context of an XR experience based on that environment.

To provide the language instruction illustrated in FIG. 2A, the device 110 may obtain information about the physical environment 100 via one or more sensors. Images captured by an image sensor, depth sensor data captured by a depth sensor, ambient light captured by an ambient light sensor, motion data captured by a motion sensor, and sound captured by microphone, as examples, may be used to recognize one or more objects (e.g., person 115, ball 140, etc.) in the physical environment or activities (e.g., the ball bouncing, the person contacting the bouncing ball, etc.). The device 110 may generate a 3D representation of the physical environment or determine positions of objects within the physical environment relative to a 3D coordinate system to facilitate providing an XR environment in which virtual content is positioned at 3D positions relative to the same 3D coordinate system.

The device 110 may use information about the physical environment and the objects within it or information about the user 105 (e.g., the user's Spanish language learning level, the user's current Spanish vocabulary list, etc.) to select and present virtual content tailored to the current context. In this example, the user is determined to have an intermediate level Spanish language proficiency and thus the virtual content includes a phase of intermediate complexity/level. If the user had been a beginner, a simpler phrase (e.g., “la pelota” (the ball)) may have been presented. If the user had been more advanced, more information of a more difficult/advanced nature may have been selected and presented.

FIG. 2B illustrates a view of another XR environment that includes depictions of the physical environment 100 of FIG. 1 and virtual content intended to facilitate learning aspects of the Spanish language. In this example, the XR environment includes depictions of aspects of the physical environment 100 of FIG. 1, e.g., including a depiction 215 of the other person 115, depiction 230 of the couch 130, and depiction 240 of the ball 140. In this example, the XR environment also provides an interactive experience by including visual and audible virtual content intended to facilitate learning the Spanish language and evaluating user actions responsive to such content. The virtual content includes a text bubble 270 with the Spanish language phrase “Qué está hacienda la persona” (What is the person doing?) and audio (signified by audio graphic 280) that presents the same phrase (“Qué está hacienda la persona”) audibly. This content queries the user for a response in the Spanish language that the device 110 can evaluate and use to provide feedback. The user 105 may respond by answering using the Spanish language, e.g., by providing a verbal or audible response such as “Él esta haciendo rebotar la pelota”. The device 110 may recognize this response via a microphone and determine that it corresponds to a correct or accurate response and provide feedback accordingly, e.g., with a correct answer chime. If an incorrect or inaccurate answer is provided, the device 110 may recognize this and provide appropriate feedback. For example, the user 105 may provide a wrong word, make a grammatical error, or mispronounce a word. The device 110 can provide feedback that indicates the error/inaccuracy or provide a correction, e.g., providing the correct word, phrase, grammar, or pronunciation to help the user 105 learn from his or her mistake.

FIG. 2C illustrates a view of another XR environment that includes depictions of the physical environment 100 of FIG. 1 and virtual content intended to facilitate learning aspects of the Spanish language. In this example, the XR environment includes depictions of aspects of the physical environment 100 of FIG. 1, e.g., including a depiction 215 of the other person 115, depiction 230 of the couch 130, and modified depiction 290 of the ball 140. In this example, the modified depiction of the ball 290 (e.g., modified with highlighting, glow effect, etc.) serves as a query to the user to identify the indicated object using a particular language, in this example, the Spanish language. The user 105 may respond by answering using the Spanish language, e.g., by providing a verbal or audible response such as “la pelota”. The device 110 may recognize this response via a microphone and determine that it corresponds to a correct or accurate response and provide feedback accordingly, e.g., with a correct answer chime. If an incorrect or inaccurate answer is provided, the device 110 may recognize this and provide appropriate feedback. For example, the user 105 may provide a wrong word, make a grammatical error, or mispronounce the word. The device 110 can provide feedback that indicates the error/inaccuracy or provide a correction, e.g., providing the correct word, phrase, grammar, or pronunciation to help the user 105 learn from his or her mistake.

In various implementations, the device 110 may provide virtual content that depends upon context in different ways. In one example, the device 110 prompts the user to identify a highlighted object (e.g., modified depiction 260 of ball 140) and evaluate the user's response based on the user's language learning level. For example, a generic word (e.g., a Spanish language word for ball) may be required for a beginner while a sport-specific word (e.g., a Spanish language word/phrase for basketball) may be required for a more advanced user.

Using virtual content to indicate particular objects or activities that are the subject of a language lesson can be particularly effective for more complicated objects. For example, if the object is a car, language lessons regarding the car as a whole can distinguish (e.g., highlight, apply a glow effect, etc.) the entire car, lessons regarding the car window can distinguish just the window, lessons regarding the color of the car can identify just the body portions of the car having the relevant color, etc. The ability to provide virtual content in 3D positions and relative to depictions of physical objects of a real-world physical environment provides these and numerous other learning advantages. Virtual content may be precisely positioned and sized to improve and maximize the effectiveness of the teaching given the learning opportunity, while also accounting for other things in the environment, e.g., without obstructing the user's view of other people or important objects.

Language learning content can be provided while a user is engaged in other activities in an XR environment. Appropriate times, positions, or methods to provide learning content can be selected based on the current context to maximize learning, avoid disturbing users engaged in other tasks, or to otherwise correspond to a user's requirements and preferences. A user wishing to study intently for a language evaluation the next day may initiate a focused learning mode and engage with a continuous interactive experience while a user wishing to casually learn over the course of weeks or months can be presented with sparser language learning content over that period. Language teachings may be initiated automatically based on context to utilize real world objects and experiences, maximize the effectiveness of the teachings over time, satisfy the user's expectations, and achieve numerous other benefits.

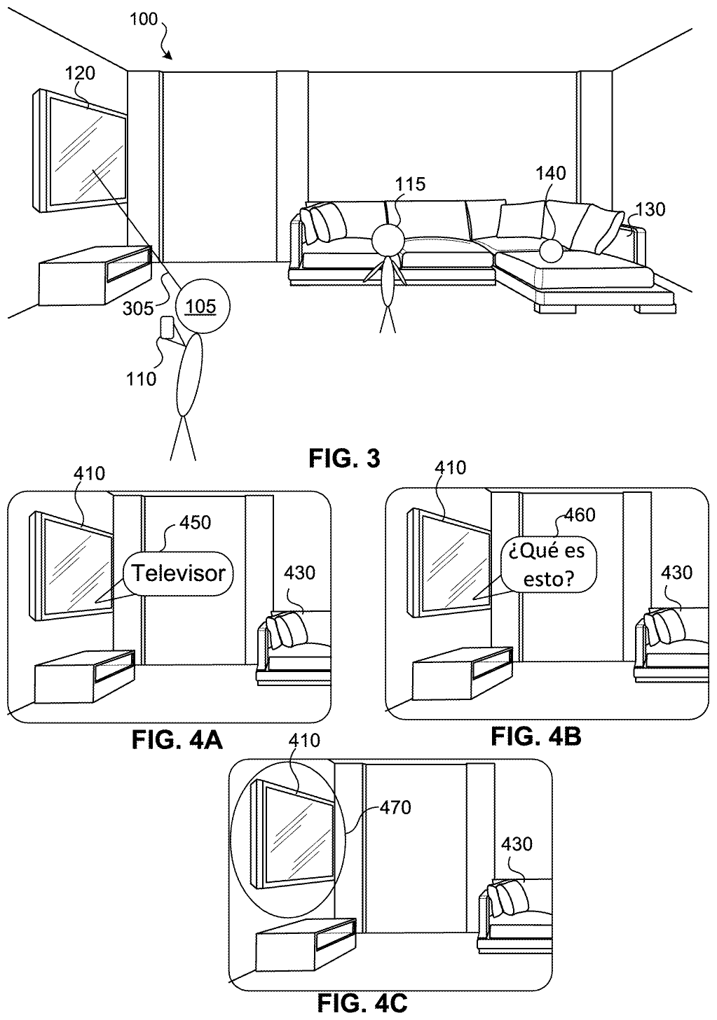

FIG. 3 illustrates electronic device 110 operating in the physical environment 100 while the user 105 is looking at the television 120. In this example, the device 110 detects that user is looking at the television 120. The device 110 may make such a determination based on one or more images of the user's eyes that may be evaluated to determined gaze direction. In another example, the device 110 determines that the user is looking at (or otherwise interested in) an object based on the user pointing at the object, holding the object, touching the object, talking about the object, or otherwise providing input or movement that can be interpreted as an indication of current interest in the object. The device 110 provides learning based on this context, e.g., based on determining that the user 105 is currently interested in the television 120.

FIGS. 4A-C illustrate depictions of language learning content provided by electronic device 100 of FIG. 3.

FIG. 4A illustrates a view of an XR environment that includes depictions of the physical environment 100 of FIG. 3 and virtual content intended to facilitate learning aspects of the Spanish language. In this example, the XR environment includes depictions of aspects of the physical environment 100 of FIG. 1, e.g., including a depiction 410 of the television 120 and a depiction 430 of the couch 130. In this example, the XR environment also includes visual and audible virtual content intended to facilitate learning the Spanish language. In particular, the XR environment includes a text bubble 450 with the Spanish language phrase “Televisor”. The user 105 thus experiences language instruction that is relevant to the user's real-world environment in the context of an XR experience in that environment. The experience is tailored to the context, e.g., that the user is looking at the television, and thus is relevant to the user's current activity. Providing language instruction based on context that is indicative of the user's current interests may enhance the effectiveness and desirability of the instruction.

FIG. 4B illustrates a view of another XR environment that includes depictions of the physical environment 100 of FIG. 3 and virtual content intended to facilitate learning aspects of the Spanish language. In this example, the XR environment includes depictions of aspects of the physical environment 100 of FIG. 1, e.g., including a depiction 410 of the television 120 and a depiction 430 of the couch 130. In this example, the XR environment also provides an interactive experience by including visual virtual content intended to facilitate learning the Spanish language. In particular, the XR environment includes a text bubble 460 with the Spanish language phrase “Qué es esto” (What is this?). This content queries the user for a response in the Spanish language that the device 110 can evaluate and use to provide feedback. The user 105 may respond by answering using the Spanish language, e.g., by providing a verbal or audible response such as “Televisor”. The device 110 may recognize this response via a microphone and determine that it corresponds to a correct or accurate response and provide feedback accordingly, e.g., with a correct answer chime. If an incorrect or inaccurate answer is provided, the device 110 may recognize this and provide appropriate feedback. For example, the user 105 may provide a wrong word, make a grammatical error, or mispronounce a word. The device 110 can provide feedback that indicates the error/inaccuracy or provide a correction, e.g., providing the correct word, phrase, grammar, or pronunciation to help the user 105 learn from his or her mistake.

FIG. 4C illustrates a view of another XR environment that includes depictions of the physical environment 100 of FIG. 1 and virtual content intended to facilitate learning aspects of the Spanish language. In this example, the XR environment includes depictions of aspects of the physical environment 100 of FIG. 1, e.g., including a depiction 410 of the television 120 and a depiction 430 of the couch 130. In this example, a graphical indicator 470 surrounds the depiction 410 of the television 120 and serves as a query to the user to identify the indicated object. The user 105 may respond by answering using the Spanish language, e.g., by providing a verbal or audible response such as “Televisor”. The device 110 may recognize this response via a microphone and determine that it corresponds to a correct or accurate response and provide feedback accordingly, e.g., with a correct answer chime. If an incorrect or inaccurate answer is provided, the device 110 may recognize this and provide appropriate feedback. For example, the user 105 may provide a wrong word, make a grammatical error, or mispronounce the word. The device 110 can provide feedback that indicates the error/inaccuracy or provide a correction, e.g., providing the correct word, phrase, grammar, or pronunciation to help the user 105 learn from his or her mistake.

In some implementations, a device (such as device 110 of FIGS. 1 and 3) uses sensors to sense objects, object locations, object movements, people, people locations, people movements, or other activities and provides language instruction for objects or activities that are likely to be of interest to a user or his or her learning. The provision of language learning content may be triggered by various circumstances. For example, it may be based on an explicit user search, the detection of certain objects, activities, or context, or user action, e.g., action such as hand placement, gaze, etc. indicating user interest in an object or activity.

The context that is used to determine when and what to present can include information about the physical environment, the user, or the user's past learning experiences. For example, an initial lesson may provide instruction regarding generic shirt concepts, a subsequent lesson may provide more detailed instruction regarding a type of shirt (e.g., t-shirt), and another subsequent lesson can provide quiz/interactive questioning regarding the shirt or t-shirt concepts. The user's vocabulary (e.g., already learned words) may be learned based on the user's lessons or the user's use of language outside of lessons. This context may be used to help tailor future lessons. For example, once the user has learned the Spanish word for “chair,” the system may determine to focus more on other objects that the user does not yet know.

In some implementations, the system recognizes one or more objects or activities in the physical environment and provides an indication (e.g., an unobtrusive glint) to signify to the user that the object or activity has been recognized and that language learning content is available. The user may then initiate the lesson by providing some input. For example, the user may look or point at one of several highlighted objects and provide an audible command asking for a lesson regarding that object. The system may detect what the user is looking or pointing at and provide a corresponding lesson. In these examples, the user's interests are the context that is used to help guide when and what language learning content is to be provided.

In some implementations, the context that is used to determine what language learning content to provide (or when to provide it) includes information about the user, such as the user's current language level/focus in the language of interest. A user may currently be focused on learning numbers and the system may thus determine to identify that there are 3 balls on the floor, 4 people in the room, a $20 bill etc.

In some implementations, a language lesson includes an interactive quiz. One type of interactive quiz asks the user to locate particular objects that are within the user's physical environment, e.g., “¿Dónde está la silla gris?” (where is the grey chair?). The user can then look at, point to, or otherwise provide input identifying an object in the physical environment that the user believes is the correct object. The device can evaluate this input and provide feedback regarding whether the user is right or wrong and, if wrong, identify the correct object. In some implementations, spatial relationships may be identified amongst objects and used to facilitate language learning. For example, based on determining that the banana is “on top of” the desk, the device may ask the user to identify where the banana is or what is on top of the desk.

In some implementations, similar objects in an environment are identified and used to teach distinctions. For example, the device may identify that the environment includes both a soccer ball and a basketball and provide language instruction distinguishing these two similar items. In other implementations, multiple objects or activities in an environment may be recognized as having associated words with similar (but different) phonetic sounds, e.g., “cansado” (tired) versus “casado” (married). The language lesson can use the XR environment to distinguish these concepts. For example, if the user erroneously describes the tired man as “casado,” the device may present “cansado” proximate the tired man in the XR environment and present virtual content that depicts an image of a married man along with “casado.”

In some implementations, the device detects sounds in the environment (e.g., dog barking, car honking, doorbell, alarm, people clapping, etc.) and provides language learning content associated with the identified sound, e.g., providing a visual or audible content item that identifies the sound using the correct language terminology.

In some implementations, context is used to determine whether it is currently an appropriate or otherwise desirable time for language learning. For example, this may involve determining whether (or how much) the user or other users in the physical environment are speaking or moving. It may involve classifying the environment or the activities in the environment (e.g., work environment, social environment, relaxing environment, play environment, etc.) and only provide language learning in certain types of environments. In another example, it involves identifying the user's current/upcoming activities based on the user's digital calendar, e.g., it's not a good time now since the user has to leave for work in 5 minutes. In another example, this may involve determining that the user has been engaged in another task for a significant amount of time and that a language learning “break” from that task is desirable.

In some implementations, the context includes words that a user is speaking or writing. For example, if the device detects the user saying a particular word in English (e.g., a word corresponding to a word on the user's current Spanish vocabulary list), the device may provide language learning content for the work in Spanish, e.g., flashing the translated Spanish word in a bubble in the environment.

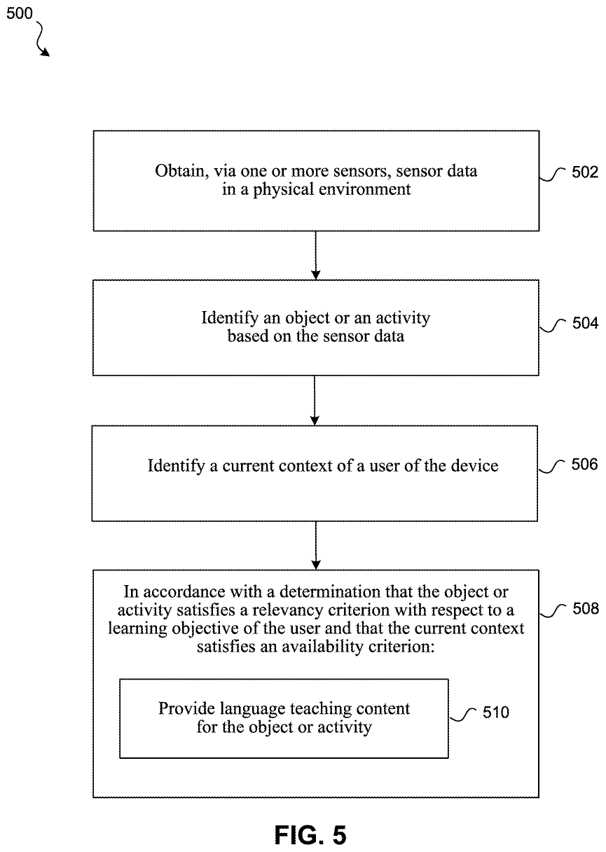

FIG. 5 is a flowchart illustrating a method 500 for providing content to facilitate language learning. In some implementations, a device such as electronic device 110 or a combination of devices performs the steps of the method 500. In some implementations, method 500 is performed on a mobile device, desktop, laptop, HMD, ear-mounted device or server device. The method 500 is performed by processing logic, including hardware, firmware, software, or a combination thereof. In some implementations, the method 500 is performed on a processor executing code stored in a non-transitory computer-readable medium (e.g., a memory).

At block 502, the method 500 obtains, via one or more sensors, sensor data in a physical environment. The sensor data may include images and/or audio of the physical environment captured via a camera or other sensor on the device (e.g., via an RGB camera, a LIDAR sensor, a microphone, an ambient light sensor, etc.). For example, as illustrated and discussed with respect to FIG. 1, sensors on device 110 in physical environment 100 may capture images, audio signals, depth data, and/or other sensor-based data regarding the physical environment 100 and/or user 105.

At block 504, the method 500 identifies an object or an activity based on the sensor data. For example, this may involve using a computer-vision based scene understanding technique to identify particular objects, their relationships, or the activities within the physical environment. In the example of FIGS. 1 and 2A-B, sensor data may be used to identify the ball 140 and/or the activity (e.g., bouncing) of the ball 140. For example, one or more images may be assessed to identify objects, classify objects as having a particular type, e.g., ball, and/or determine based on one or more images obtained over a period of time, an activity that is occurring, about to occur, or that recently occurred, e.g., the ball is bouncing

At block 506, the method 500 identifies a current context of a user of the device. For example, the current context of the user may include other user activity/plans that indicate whether here and now is good for language instruction. In some implementations, the current context includes the current time of day, the current location, a classification of the user's room type or environment (e.g., dining room, office, park, retail store, restaurant, etc.), what the user is interacting with, holding, pointing at, or looking at, who the user is talking to, etc. In the example of FIGS. 1 and 2A-C, determining the current context may involve determining the type of the user's current environment, the time of day, whether others are present, whether the user is occupied with a telephone call, on a device, walking, sitting, or engaged in any other activity, etc. The current context may include the user's current lessons, e.g., the subject matter of the user's Spanish class this week.

The method 500 may identify an indication of user (or other person's) interest in an object/activity. The interest may be determined based determining what the user is looking at, what the user is holding/touching/contacting, what the user is doing, what is moving in the environment, the user's prior interest in a particular type of object or activity, etc. In another example, the method 500 may determine the relevance of an object, activity, or environment type to the user's current topic or lesson, such as this week's 20 Spanish vocabulary words.

In another example, the method 500 determines the user's language level/current vocabulary/history which, for example, may be determined based on observing the user's use of language. The context may include a factor indicator of whether the language teaching content conflict with a user activity or plan.

At block 508, in accordance with a determination that the object or activity satisfies a relevancy criterion with respect to a learning objective of the user and that the current context satisfies an availability criterion, the method 500 performs block 510 to provide language teaching content for the object or activity. The language teaching content may be visual or audio. In the example of FIG. 2A, exemplary provided language teaching content includes a text bubble 250 with the Spanish language phrase “Él está haciendo rebotar la pelota” (He is bouncing the ball) and audio (signified by audio graphic 260) that presents the same phrase (“Él está haciendo rebotar la pelota”) audibly. In the example of FIG. 2B, exemplary provided language teaching content includes the text bubble 270 with the Spanish language phrase “Que está hacienda la persona” (What is the person doing?) and audio (signified by audio graphic 280) that presents the same phrase (“Qué está hacienda la persona”) audibly. In the example of FIG. 2C, exemplary provided language teaching content includes the modified depiction of the ball 290 (e.g., modified with highlighting, glow effect, etc.).

The relevancy criterion may be determined based on (a) an indication of interest in an object/activity determined based on gaze, holding, touching, etc. or (b) relevance of an object/activity/environment type to the user's current topic or lesson, such as this week's 20 Spanish vocabulary words. In some implementations, the object or activity satisfying the relevancy criterion is based on determining that there is an indication of interest in the object or the activity. Identifying the indication of interest in the object or activity may be based on determining that the user's gaze corresponds to the object or activity or the user has contacted the object. In some implementations, the object or activity satisfying the relevancy criterion is based on determining that the object, the activity, or a type of the physical environment relates to a lesson topic.

The availability criterion may be determined based on various factors. In some implementations, the current context satisfying the availability criterion is based on determining: a current activity of the user; a plan of the user regarding a current time; a current time of day; a current location of the user; whether other persons are present; a type of the physical environment; with what the user is interacting; at what the user is gazing; or whether the user is occupied. Such information may be indicative of whether now is good time and circumstance for providing a language lesson. For example, current activity or future plans indicating the user is not occupied with another activity, the location being a particular type of location, no other people being around, etc.

In some implementations, providing language teaching content for the object or activity comprises positioning the language teaching content within an extended reality (XR) environment based on a position of the object or activity. For example, the location of the language teaching content may be spatially positioned proximate to or otherwise close to the object or activity to which it relates. The language teaching content is positioned at a three-dimensional (3D) location based on a 3D location of the object or activity.

The method 500 may determine that the object or activity satisfies the relevancy criterion with respect to the learning objective of the user and that the current context satisfies the availability criterion and take one or actions based on these determinations. For example, in accordance with such determinations, the method 500 may obtain the language teaching content for the object or activity. The language teaching content that is obtained may be based on a user level that is associated with the user or determined based on observing the user's use of the language. The user level may include a language level, current vocabulary, or history of a user.

In some implementations, the current context is used to additionally determine a scale or focus for the language teaching content (e.g., different scale dictating whether the content is car, car door, car door handle, etc.).

In some implementations, the current context is used to additionally determine a teaching level for the language teaching content based on the context (e.g., different teaching level dictating noun specificity: clothing, shirt, t-shirt, etc. or content complexity: ball, ball rolling, ball rolling down the street, etc.)

A teaching or user level may be used to determine what language content to present. For example, such a level may be used to determine a scale for the language teaching content, for example, with respect to level of detail, specificity, or scale dictates whether the content is specific to a car, a car door, a car door handle, etc. The user level may be used to determine a teaching level for the language teaching content. Similarly, different teaching levels may be used to determine noun specificity, e.g., clothing, shirt, t-shirt, etc. or content complexity: ball, ball rolling, ball rolling down the street, etc.

In some implementations, in accordance with the determination that the object or activity satisfies the relevancy criterion with respect to the learning objective of the user and that the current context satisfies the availability criterion, the method 500 obtains the language teaching content for the object or activity based on a user history. The user history may be determined based on observing use of the language by the user. This may involve capturing audio, text, or other input from a user and analyzing the captured input for complexity, grammar, errors, or other level indications to determine the user level.

In some implementations, in accordance with a determination the object or activity does not satisfy the relevancy criterion with respect to the learning objective of the user or that the current context does not satisfies the availability criterion, the method 500 forgoes providing the language teaching content.

In some implementations, the provided language teaching content provides a prompt for the user to provide a response by saying a word or phrase, where the response is used to determine a user level. User responses may be evaluated and used to determine additional content to provide to the user. A back and forth, question and answer or other formatted dialog may be provided to enable a user to practice language skills, e.g., what is this object?, ball, correct—what color is the ball?, red, correct—what sport uses the red ball?, basketball, correct—is the basketball bouncing?, yes, etc.

In some implementations, after using a first user level to provide a first language teaching content, the method 500 detects a re-occurrence of the object or activity. The method 500 determines an updated/second user level and uses this updated/second user level to determine and provide a second language teaching content different than the first language teaching content during a re-occurrence of the object or activity in the user's environment. Accordingly, the method 500 may over time present different and reinforcing and progressively more advanced language teaching content to a user as the user progresses with his or her language learning.

In some implementations, the current content that is used to determine whether the availability criterion is satisfied is based on determining that the current context includes an indication of interest in the object or the activity. Such an indication of interest in the object or activity may be identified based on determining that the user's gaze corresponds to the object or activity. In another example, such an indication of interest in the object may be determined based on determining that the user contacts the object, points at the object, holds the object, talks about the object, etc.

In some implementations, determining that the current context satisfies the availability criterion is based on determining that that the object, the activity, or a type of the physical environment relates to a lesson topic. For example, the user's current weekly plan may relate to transportation objects and the current context satisfying the availability criterion may involve determining that one or more objects in the user's current physical environment correspond to that lesson, e.g., the objects being bicycles, scooters, automobiles, etc.

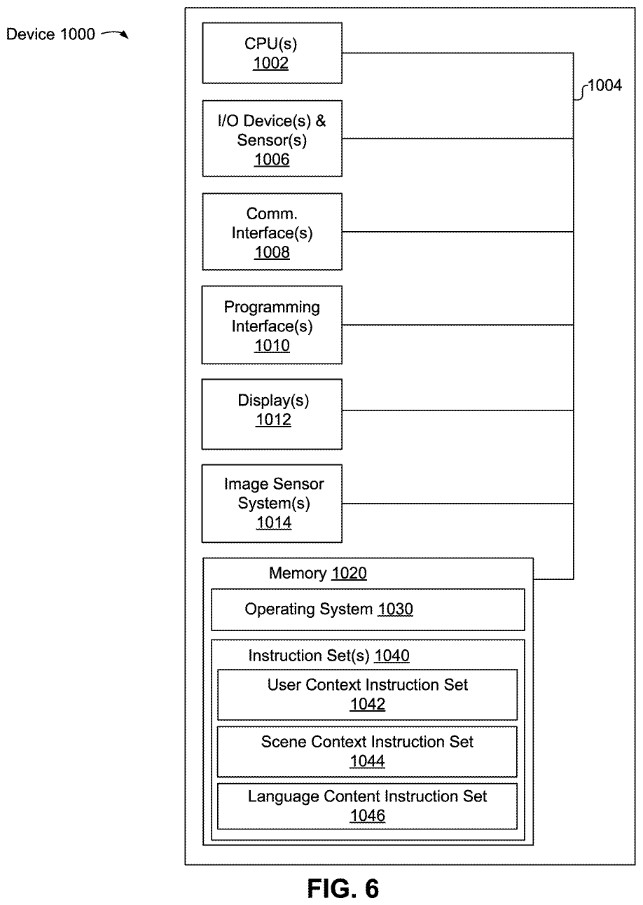

FIG. 6 is a block diagram of electronic device 1000. Device 1000 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 1010, one or more output device(s) 1012, one or more interior or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like.

In some implementations, the one or more output device(s) 1012 include one or more displays configured to present a view of a 3D environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include a user context instruction set 1042 configured to, upon execution, determine a user context for language learning content, as described herein. The instruction set(s) 1040 further include a scene context instruction set 1044 configured to, upon execution, determine a context associated with a physical environment as described herein. The instruction set(s) 1040 further include a language content instruction set 1046 configured to, upon execution, generate and present language learning content, as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information or physiological data will comply with well-established privacy policies or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor and one or more sensors:
obtaining, via the one or more sensors, sensor data in a physical environment;
identifying an object or an activity in the physical environment based on the sensor data;
identifying a current context of a user of the device; and
in accordance with a determination that the object or activity satisfies a relevancy criterion with respect to a learning objective of the user and that the current context satisfies an availability criterion:
providing language teaching content for the object or activity.

2. The method of claim 1, wherein the sensor data comprises images of the physical environment or audio of the physical environment.

3. The method of claim 1, wherein providing language teaching content for the object or activity comprises positioning the language teaching content within an extended reality (XR) environment based on a position of the object or activity.

4. The method of claim 1 further comprising, in accordance with the determination that the object or activity satisfies the relevancy criterion with respect to the learning objective of the user and that the current context satisfies the availability criterion, obtaining the language teaching content for the object or activity based on a user level or a user history determined based on observing use of the language by the user.

5. The method of claim 1 further comprising, in accordance with a determination the object or activity does not satisfy the relevancy criterion with respect to the learning objective of the user or that the current context does not satisfies the availability criterion, forgo providing the language teaching content.

6. The method of claim 1, wherein the teaching content comprises a prompt for the user to provide a response by saying a word or phrase, wherein the method further comprises:
determining a user level based on a response to the prompt;
detecting a re-occurrence of the object or activity following the providing of the language teaching content; and
based on detecting the re-occurrence of the object or activity and the determined user level, providing a second language teaching content different than the language teaching content.

7. The method of claim 1, wherein the object or activity satisfying the relevancy criterion is based on determining that there is an indication of interest in the object or the activity, wherein determining that there is the indication of interest in the object or the activity is based on determining that:
the user's gaze corresponds to the object or activity, or
the user has contacted the object.

8. The method of claim 1, wherein the object or activity satisfying the relevancy criterion is based on determining that the object, the activity, or a type of the physical environment relates to a lesson topic.

9. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining, via the one or more sensors, sensor data in a physical environment;
identifying an object or an activity in the physical environment based on the sensor data;
identifying a current context of a user of the device; and
in accordance with a determination that the object or activity satisfies a relevancy criterion with respect to a learning objective of the user and that the current context satisfies an availability criterion:
providing language teaching content for the object or activity.

10. The system of claim 9, wherein the sensor data comprises images of the physical environment or audio of the physical environment.

11. The system of claim 9, wherein providing language teaching content for the object or activity comprises positioning the language teaching content within an extended reality (XR) environment based on a position of the object or activity.

12. The system of claim 9, wherein the operations further comprise, in accordance with the determination that the object or activity satisfies the relevancy criterion with respect to the learning objective of the user and that the current context satisfies the availability criterion, obtaining the language teaching content for the object or activity based on a user level or a user history determined based on observing use of the language by the user.

13. The system of claim 9, wherein the operations further comprise, in accordance with a determination the object or activity does not satisfy the relevancy criterion with respect to the learning objective of the user or that the current context does not satisfies the availability criterion, forgo providing the language teaching content.

14. The system of claim 9, wherein the teaching content comprises a prompt for the user to provide a response by saying a word or phrase, wherein the method further comprises:
determining a user level based on a response to the prompt;
detecting a re-occurrence of the object or activity following the providing of the language teaching content; and
based on detecting the re-occurrence of the object or activity and the determined user level, providing a second language teaching content different than the language teaching content.

15. The system of claim 9, wherein the object or activity satisfying the relevancy criterion is based on determining that there is an indication of interest in the object or the activity, wherein determining that there is the indication of interest in the object or the activity is based on determining that:
the user's gaze corresponds to the object or activity, or
the user has contacted the object.

16. The system of claim 9, wherein the object or activity satisfying the relevancy criterion is based on determining that the object, the activity, or a type of the physical environment relates to a lesson topic.

17. A non-transitory computer-readable storage medium storing program instructions executable via one or more processors to perform operations comprising:
obtaining, via the one or more sensors, sensor data in a physical environment;
identifying an object or an activity in the physical environment based on the sensor data;
identifying a current context of a user of the device;
in accordance with a determination that the object or activity satisfies a relevancy criterion with respect to a learning objective of the user and that the current context satisfies an availability criterion:
providing language teaching content for the object or activity.

18. The non-transitory computer-readable storage medium of claim 17, wherein the sensor data comprises images of the physical environment or audio of the physical environment.

19. The non-transitory computer-readable storage medium of claim 17, wherein providing language teaching content for the object or activity comprises positioning the language teaching content within an extended reality (XR) environment based on a position of the object or activity.

20. The non-transitory computer-readable storage medium of claim 17, wherein the operations further comprise, in accordance with the determination that the object or activity satisfies the relevancy criterion with respect to the learning objective of the user and that the current context satisfies the availability criterion, obtaining the language teaching content for the object or activity based on a user level or a user history determined based on observing use of the language by the user.

21. The non-transitory computer-readable storage medium of claim 17, wherein the operations further comprise, in accordance with a determination the object or activity does not satisfy the relevancy criterion with respect to the learning objective of the user or that the current context does not satisfies the availability criterion, forgo providing the language teaching content.

22. The non-transitory computer-readable storage medium of claim 17, wherein the teaching content comprises a prompt for the user to provide a response by saying a word or phrase, wherein the method further comprises:
determining a user level based on a response to the prompt;
detecting a re-occurrence of the object or activity following the providing of the language teaching content; and
based on detecting the re-occurrence of the object or activity and the determined user level, providing a second language teaching content different than the language teaching content.

23. The non-transitory computer-readable storage medium of claim 17, wherein the object or activity satisfying the relevancy criterion is based on determining that there is an indication of interest in the object or the activity, wherein determining that there is the indication of interest in the object or the activity is based on determining that:
the user's gaze corresponds to the object or activity, or
the user has contacted the object.

24. The non-transitory computer-readable storage medium of claim 17, wherein the object or activity satisfying the relevancy criterion is based on determining that the object, the activity, or a type of the physical environment relates to a lesson topic.
